(19) United States
(12) Patent Application Publication
(10) Pub. No.: US 2003/0070335 A1
(43) Pub. Date: Apr. 17, 2003

(54) Decorated self-adhesive residential and commercial exterior garage doors

(76) Inventor: Richard Soo Kim, Austin, TX (US)

Correspondence Address: RICHARD SOO KIM, 1008 CASSAT COVE, Austin, TX, 78753, US

(21) Appl. No.: 09/850,161

(22) Filed: Aug. 13, 2001

(51) Int. Cl. G09F 7/12

(52) U.S. Cl. 40/594

(57) ABSTRACT

I believe that my claim of “DECORATED SELF-ADHESIVE STICKER FOR RESIDENTIAL AND COMMERCIAL GARAGE DOORS” utiliztig self-adhesive sticker material to transfer non-copyrighted or non-trademarked images to adhere to the garage doors will brighten any neighborhood and give each house the distinct personality that will separate it from the rest.

A brief background in this invention is by continuous driving through my neighborhood, I have observed homes that looked alike. I wanted to add some personality to my home and give it some distinction. After additional considerations, I recognized that most homes have their garages in the front of the house. The doors looked plain and bland with just painted doors. By utilizing this space for decoration, I came up with the idea of adding imagery onto this medium

My invention would use a large commercial printer to print captured images onto self-adhesive sticker material (i.e. plastic, vinyl, synthetic or rubber, or any other similar material that will last a minimum of ten years), separate it according to the number of panels that make up the garage door and apply the stickers onto the door to make one complete image that people can view when the garage door is closed.

Self-adhesive sticker material made out of moisture-resistant material are able to resist curling and aging during extreme temperatures from −50 to 150 degrees Fahrenheit. It Is also very easy to maintain, as it is washable with soap and water.

Consumers can choose any none-copyrighted or non-trademarked images (i.e. personal artwork and/or pictures, etc.) and have it transferred onto their garage doors via the self-adhesive sticker material mentioned above.

When a home or business owner gets tired of the image, whether in months or years, they can easily remove the image and replace it with another one or paint the door to their liking of color.

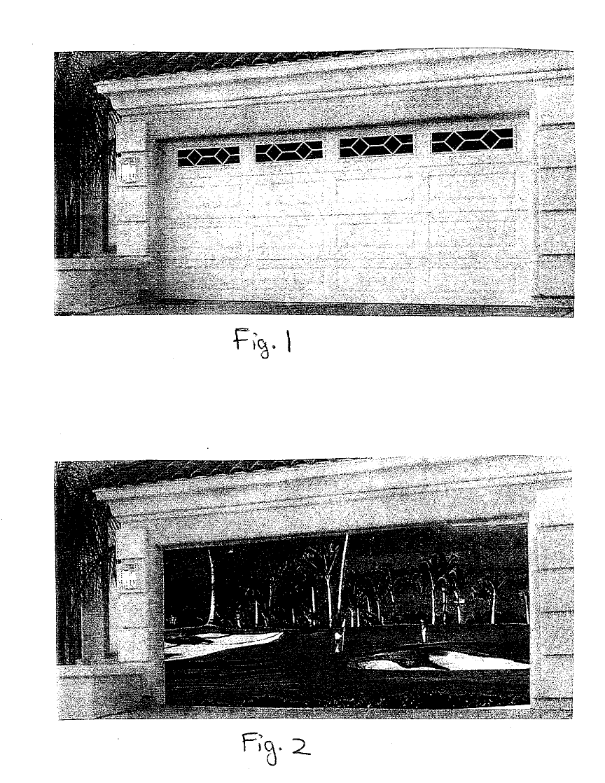

FIG. 1: A typical residential or commercial garage door.

FIG. 2: Decorated self-adhesive sticker attached to a residential or commercial garage door.

1. The claim I am requesting far a U.S. Patent is a decorated self-adhesive sticker for residential and commercial exterior garage doors. This can include ant rolling and/or sectional doors. I have researched and have not found any related applications pertaining to my claim.
